(19) United States
(12) Patent Application Publication
(10) Pub. No.: US 2023/0422343 A1
(43) Pub. Date: Dec. 28, 2023

(54) METHOD AND APPARATUS FOR CONFIGURING DISCONTINUOUS RECEPTION PARAMETER, AND COMMUNICATION DEVICE AND STORAGE MEDIUM

(71) Applicants: BEIJING XIAOMI MOBILE SOFTWARE CO., LTD., Beijing (CN); BEIJING UNIVERSITY OF POSTS AND TELECOMMUNICATIONS, Beijing (CN)

(72) Inventors: Qin MU, Beijing (CN); Wei HONG, Beijing (CN); Zhongyuan ZHAO, Beijing (CN); Jingyi WANG, Beijing (CN); Chao JIA, Beijing (CN)

(73) Assignees: BEIJING XIAOMI MOBILE SOFTWARE CO., LTD., Beijing (CN); BEIJING UNIVERSITY OF POSTS AND TELECOMMUNICATIONS, Beijing (CN)

(21) Appl. No.: 18/255,532

(22) PCT Filed: Dec. 1, 2020
(86) PCT No.: PCT/CN2020/133171

§ 371 Date: Jun. 1, 2023

(51) Int. Cl. H04W 76/28

(52) U.S. Cl. CPC H04W 76/28

(57) ABSTRACT

Aspects of the invention can provide a method for configuring a discontinuous reception (DRX) parameter, which method is applied to a base station. The method can include, according to first discontinuous reception (DRX) transmission feature data, configuring a discontinuous reception (DRX) parameter for a terminal, wherein the first discontinuous reception (DRX) transmission feature data is discontinuous reception (DRX) transmission feature data for discontinuous reception (DRX) transmission performed by the terminal at historical moments.

### CROSS-REFERENCE TO RELATED APPLICATION

The present application is a National Stage of International Application No. PCT/CN2020/133171, filed on Dec. 1, 2020, the contents of all of which are incorporated herein by reference in their entireties for all purposes.

### BACKGROUND OF THE INVENTION

### Field of the Invention

The present disclosure relates to the technical field of wireless communication but is not limited to the technical field of wireless communication, and in particular, relates to a method, apparatus, communication device and storage medium for configuring discontinuous reception (DRX) parameters.

### Description of the Related Art

The power consumption of an electronic device directly affects the battery life of the electronic device. Therefore, the power consumption of the electronic device is defined as one of the key technical performance indicators of network communication. Since the New Radio (NR, New Radio) system supports high-speed data transmission, burst data transmission can be completed in a very short time. An effective way to save energy is that the electronic device will stay in the energy saving mode unless the network notifies the electronic device to access the network, which is beneficial to the energy saving of the electronic device.

In the related art, a discontinuous reception (DRX, Discontinuous Reception) method can be used to make the electronic device work in the energy saving mode.

### SUMMARY OF THE INVENTION

Embodiments of the present disclosure disclose a method, apparatus, communication device, and storage medium for configuring discontinuous reception (DRX) parameters.

According to a first aspect of the embodiments of the present disclosure, a method for configuring discontinuous reception (DRX) parameter, which is applied to a base station, including configuring discontinuous reception (DRX) parameter of a terminal according to a first DRX transmission feature data. The first discontinuous reception (DRX) transmission feature data is discontinuous reception (DRX) transmission feature data of discontinuous reception (DRX) transmission performed by the terminal at a historical moment.

In one embodiment, configuring the discontinuous reception (DRX) parameter of the terminal includes, in response to the discontinuous reception (DRX) parameter of the terminal being not configured at the current moment, configuring the discontinuous reception (DRX) parameter of the terminal as a first discontinuous reception (DRX) parameter. The first discontinuous reception (DRX) parameter is determined based on the first discontinuous reception (DRX) transmission feature data or, in response to the DRX parameter of the terminal being configured as a second DRX parameter at the current moment, configuring the discontinuous reception (DRX) parameter of the terminal according to a matching result between the first DRX parameter and the second DRX parameter.

In one embodiment, configuring the discontinuous reception (DRX) parameters of the terminal according to the matching result between the first discontinuous reception (DRX) parameter and the second discontinuous reception (DRX) parameter includes, in response to the first discontinuous reception (DRX) parameter not matching the second discontinuous reception (DRX) parameter, reconfiguring the discontinuous reception (DRX) parameter of the terminal as the first discontinuous reception (DRX) parameter, or, in response to the first discontinuous reception (DRX) parameter matching the second discontinuous reception (DRX) parameter, not reconfiguring the discontinuous reception (DRX) parameter of the terminal.

In one embodiment, the method comprises: determining a predicted service type by inputting second discontinuous reception (DRX) transmission feature data into a trained neural network model. The trained neural network model is a neural network model for predicting service type and the neural network model is trained by using the first DRX transmission feature data. The second discontinuous reception (DRX) transmission feature data is discontinuous reception (DRX) transmission feature data of discontinuous reception (DRX) transmission performed by the terminal at a current moment, determining the first discontinuous reception (DRX) parameter according to the predicted service type.

In one embodiment, determining the first discontinuous reception (DRX) parameter according to the predicted service type can include determining the first discontinuous reception (DRX) parameter from a plurality of predetermined discontinuous reception (DRX) parameters according to a power consumption threshold corresponding to the predicted service type. The power consumption thresholds of different service types are different, the predetermined discontinuous reception (DRX) parameters are discontinuous reception (DRX) parameters of discontinuous reception (DRX) transmissions performed at historical moments.

In one embodiment, determining the first discontinuous reception (DRX) parameter from a plurality of predetermined discontinuous reception (DRX) parameters according to the power consumption threshold corresponding to the predicted service type includes determining the first discontinuous reception (DRX) parameter from a plurality of predetermined discontinuous reception (DRX) parameters according to at least the power consumption threshold and a correspondence between power consumption thresholds and the predetermined discontinuous reception discontinuous reception (DRX) parameters.

In one embodiment, the discontinuous reception (DRX) transmission feature data includes discontinuous reception (DRX) transmission feature data obtained from an OAM network element.

In one embodiment, the discontinuous reception (DRX) transmission feature data includes at least one of the following: data of traffic performance, data of channel transmission performance, and data of energy consumption.

According to a second aspect of the embodiments of the present disclosure, device for configuring DRX transmission feature parameter is provided, wherein, applied to a base station, the device can include a configuration module, wherein, the configuration module is configured to: configure a discontinuous reception (DRX) parameter of a terminal according to first discontinuous reception (DRX) transmission feature data. The first discontinuous reception (DRX) transmission feature data is discontinuous reception (DRX) transmission feature data of discontinuous reception (DRX) transmission performed by the terminal at a historical moment.

In one embodiment, the configuration module is also configured to, in response to the discontinuous reception (DRX) parameter of the terminal being not configured at a current moment, configure the discontinuous reception (DRX) parameter of the terminal as a first discontinuous reception (DRX) parameter. The first discontinuous reception (DRX) parameter is determined based on the first discontinuous reception (DRX) transmission feature data or, in response to the discontinuous reception (DRX) parameter of the terminal being configured as a second discontinuous reception (DRX) parameter at a current moment, configure the discontinuous reception (DRX) parameter of the terminal according to a matching result between a first discontinuous reception (DRX) parameter and the second discontinuous reception (DRX) parameter.

In one embodiment, the configuration module is further configured to, in response to the first discontinuous reception (DRX) parameter not matching the second discontinuous reception (DRX) parameter, reconfigure the discontinuous reception (DRX) parameter of the terminal as the first discontinuous reception (DRX) parameter, or, in response to the first discontinuous reception (DRX) parameter matching the second discontinuous reception (DRX) parameter, not reconfigure the discontinuous reception (DRX) parameter of the terminal.

In one embodiment, the apparatus further comprises a determining module, wherein the determining module is configured to determine a predicted service type by input second DRX transmission feature data into a trained neural network model. The trained neural network model is a neural network model for predicting service type, and the neural network model is trained by using the first discontinuous reception (DRX) transmission feature data. The second discontinuous reception (DRX) transmission feature data is the discontinuous reception (DRX) transmission feature data of discontinuous reception (DRX) transmission performed by the terminal at the current moment, determine the first discontinuous reception (DRX) parameter according to the predicted service type.

In one embodiment, the determining module is further configured to determine the first DRX parameter from a plurality of predetermined DRX parameters according to a power consumption threshold corresponding to the predicted service type. The power consumption thresholds of different service types are different, the predetermined DRX parameters are DRX parameters of DRX transmissions performed at historical moments.

In one embodiment, the determining module is further configured to determine the first DRX parameter from a plurality of predetermined DRX parameters according to at least the power consumption threshold and a correspondence between power consumption thresholds and the predetermined discontinuous reception DRX parameters.

In one embodiment, the DRX transmission feature data, includes DRX transmission feature data obtained from an operation, maintenance and management (OAM) network element.

In one embodiment, the DRX transmission feature data including at least one of the following: data of traffic performance, data of channel transmission performance, and data of energy consumption.

According to a third aspect of embodiments of the present disclosure, a communication device is provided, the communication device including a processor and a memory for storing executable instructions which can be executed by the processor. The processor is configured to run the executable instructions to achieve methods according to any embodiment of the present disclosure.

According to a fourth aspect of embodiments of the present disclosure, a computer storage medium is provided, the computer storage medium stores non-transitory computer-executable instructions, which can implement the method provided by any one of embodiments of the present disclosure when executed by a processor.

### BRIEF DESCRIPTION OF THE DRAWINGS

Various exemplary embodiments of this disclosure that are proposed as examples will be described in detail with reference to the following figures, wherein like numerals reference like elements, and wherein:

FIG. 1 is a schematic structural diagram of a wireless communication system.

FIG. 2 is a schematic diagram showing a discontinuous reception (DRX) cycle according to an exemplary embodiment.

FIG. 3 is a schematic flowchart of a method for configuring discontinuous reception (DRX) parameters according to an exemplary embodiment.

FIG. 4 is a schematic flowchart of a base station acquiring discontinuous reception (DRX) transmission feature data from an operation administration maintenance (OAM) network element according to an exemplary embodiment.

FIG. 5 is a schematic flowchart of a method for configuring discontinuous reception (DRX) parameters according to an exemplary embodiment.

FIG. 6 is a schematic flowchart of a method for configuring discontinuous reception (DRX) parameters according to an exemplary embodiment.

FIG. 7a is a schematic flowchart of a method for configuring discontinuous reception (DRX) parameters according to an exemplary embodiment.

FIG. 7b is a schematic diagram of a wireless communication system according to an exemplary embodiment.

FIG. 8 is a schematic flowchart of a method for configuring discontinuous reception (DRX) parameters according to an exemplary embodiment.

FIG. 9 is a schematic flowchart of a method for configuring discontinuous reception (DRX) parameters according to an exemplary embodiment.

FIG. 10 is a schematic flowchart of a method for configuring discontinuous reception (DRX) parameters according to an exemplary embodiment.

FIG. 11 is a schematic flowchart of a method for configuring discontinuous reception (DRX) parameters according to an exemplary embodiment.

FIG. 12 is a schematic flowchart of a method for configuring discontinuous reception (DRX) parameters according to an exemplary embodiment.

FIG. 13 is a schematic diagram of an apparatus for configuring discontinuous reception (DRX) parameters according to an exemplary embodiment.

FIG. 14 is a schematic structural diagram of a terminal according to an exemplary embodiment.

FIG. 15 is a block diagram of a base station according to an exemplary embodiment.

### DETAILED DESCRIPTION OF THE PREFERRED EMBODIMENTS

Exemplary embodiments will be described in detail herein, examples of which are illustrated in the accompanying drawings. Where the following description refers to the drawings, the same numerals in different drawings refer to the same or similar elements unless otherwise indicated. The implementations described in the following exemplary embodiments are not intended to represent all implementations consistent with embodiments of the present disclosure. Rather, they are merely examples of apparatus and methods consistent with some aspects of embodiments of the present disclosure, as recited in the appended claims.

The terms used in the embodiments of the present disclosure are only for the purpose of describing particular embodiments, and are not intended to limit the embodiments of the present disclosure. As used in the embodiments of the present disclosure and the appended claims, the singular forms “a” and “the” are intended to include the plural forms as well, unless the context clearly indicates its meaning otherwise. It will also be understood that the term “and/or” as used herein refers to and includes any and all possible combinations of one or more of the associated listed items.

It should be understood that although the terms first, second, third, etc. may be used in embodiments of the present disclosure to describe various pieces of information, such information should not be limited to these terms. These terms are only used to distinguish the same type of information from each other. For example, without departing from the scope of the embodiments of the present disclosure, the first information may also be referred to as the second information, and similarly, the second information may also be referred to as the first information. Depending on the context, the word “if” as used herein can be interpreted as “at the time of” or “when” or “in response to determining.”

For the purpose of brevity and ease of understanding, the terms “greater than” or “less than” are used herein when characterizing the relationship of size. However, those skilled in the art can understand that the term “greater than” also covers the meaning of “greater than or equal to”, and “less than” also covers the meaning of “less than or equal to”.

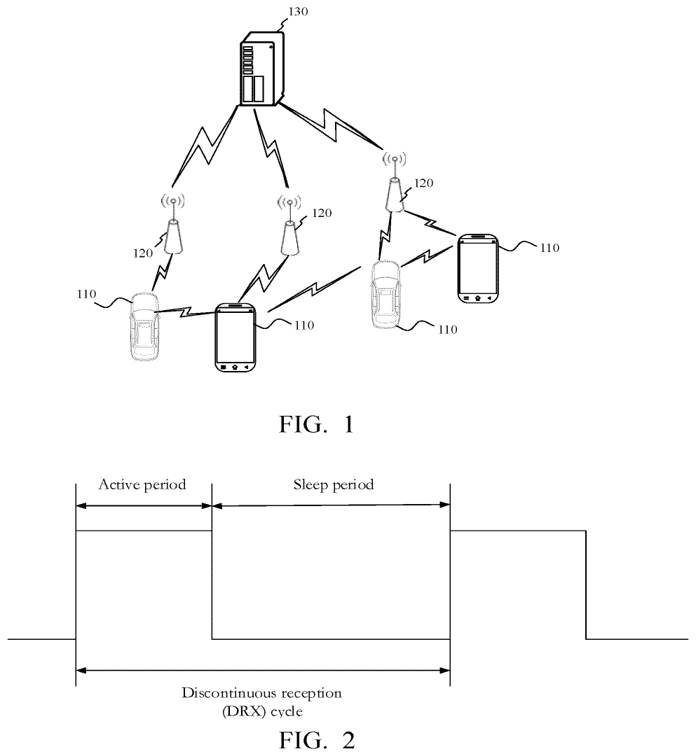

Please refer to FIG. 1, which shows a schematic structural diagram of a wireless communication system provided by an embodiment of the present disclosure. As shown in FIG. 1, the wireless communication system is a communication system based on cellular mobile communication technology, and the wireless communication system may include several user equipment 110 and several base stations 120.

The user equipment 110 may be a device that provides voice and/or data connectivity to the user. The user equipment 110 may communicate with one or more core networks via a Radio Access Network (RAN). The user equipment 110 may be an IoT user equipment such as a sensor device, a mobile phone (or referred to as a “cellular” phone)) and a computer with IoT user equipment. For example, the user equipment 110 may be stationary, portable, pocket-sized, hand-held, computer-built or vehicle-mounted. For example, the user equipment 110 may be a station (STA), a subscriber unit, a subscriber station, a mobile station, a mobile, a remote station, an access point, a remote user equipment, an access terminal, a user terminal, a user agent, a user device, or user equipment. Alternatively, the user equipment 110 may also be a device of an unmanned aerial vehicle. Alternatively, the user equipment 110 may also be an in-vehicle device, for example, a trip computer with a wireless communication function, or a wireless user equipment connected to an external trip computer. Alternatively, the user equipment 110 may also be a roadside device, for example, may be a street light, a signal light, or other roadside devices with a wireless communication function.

The base station 120 may be a network-side device in a wireless communication system. The wireless communication system may be a 4th generation mobile communication (4G) system, also known as a Long Term Evolution (LTE) system; or, the wireless communication system may also be a 5G system, also known as New Radio System or 5G NR System. Alternatively, the wireless communication system may also be a next-generation system of the 5G system. The access network in the 5G system may be called NG-RAN (New Generation-Radio Access Network).

The base station 120 may be an evolved base station (eNB) used in the 4G system. Alternatively, the base station 120 may also be a base station (gNB) that adopts a centralized distributed architecture in a 5G system. When the base station 120 adopts a centralized distributed architecture, it usually includes a central unit (CU) and at least two distributed units (DU). The central unit is provided with a protocol stack of a packet data convergence protocol (PDCP) layer, a radio link layer control protocol (Radio Link Control, RLC) layer, and a media access control (MAC) layer; the distributed units are provided with a physical (PHY) layer protocol stack, and the specific implementation manner of the base station 120 is not limited in this embodiment of the present disclosure.

A wireless connection can be established between the base station 120 and the user equipment 110 through a wireless air interface. In one or more different embodiments, the wireless air interface is a wireless air interface based on the fourth generation mobile communication network technology (4G) standard; or, the wireless air interface is a wireless air interface based on the fifth generation mobile communication network technology (5G) standard, for example the wireless air interface is a new air interface; alternatively, the wireless air interface may also be a wireless air interface based on a next-generation of 5G mobile communication network technology standard.

In some embodiments, an E2E (End to End) connection may also be established between the user equipment 110, for example, in the scenarios such as V2V (vehicle to vehicle) communication, V21 (vehicle to Infrastructure, vehicle-to-roadside equipment) communication and V2P (vehicle to pedestrian) communication in vehicle to everything (V2X) communication.

Here, the above-mentioned user equipment may be regarded as the terminal device of the following embodiments.

In some embodiments, the above wireless communication system may further include a network management device 130.

Several base stations 120 are respectively connected to the network management device 130. The network management device 130 may be a core network device in a wireless communication system. For example, the network management device 130 may be a Mobility Management Entity (MME) in an Evolved Packet Core (EPC) network. Alternatively, the network management device may also be other core network devices, such as a serving gateway (SGW), a public data network gateway (PGW), a policy and charging rules function (PCRF) unit or a Home Subscriber Server (HSS), etc. The implementation form of the network management device 130 is not limited in this embodiment of the present disclosure.

In order to better understand the technical solutions described in any of the embodiments of the present disclosure, firstly, an energy saving manner for the terminal to perform data transmission is described.

The use of discontinuous reception (DRX) transmission mode for data transmission can effectively achieve energy saving.

In one embodiment, referring to FIG. 2, a discontinuous reception (DRX) cycle includes an active period and a sleep period.

In one embodiment, a wake-up signal (WUS) is introduced in the radio resource control (RRC) connected state, and the wake-up signal (WUS) can indicate whether the terminal needs to monitor the Physical Downlink Control Channel (PDCCH) before the arrival of each active period of the discontinuous reception (DRX).

In one embodiment, if no downlink data is sent, the wake-up signal (WUS) instructs the terminal to sleep in the next discontinuous reception (DRX) cycle. Otherwise, the terminal monitors the physical downlink control channel (PDCCH) in the next active period of discontinuous reception (DRX).

In one embodiment, the base station may dynamically adjust discontinuous reception (DRX) parameters configured for the terminal based on specific parameters. Here, the specific parameters may be wireless communication quality, amount of data to be transmitted, time delay requirements, and the like.

In one embodiment, the base station may configure a plurality of different discontinuous reception (DRX) parameters for the terminal.

In one embodiment, the base station may select one discontinuous reception (DRX) parameter from a plurality of different discontinuous reception (DRX) parameters to configure the discontinuous reception (DRX) parameter of the terminal.

In one embodiment, the base station selects a discontinuous reception (DRX) parameter from a plurality of discontinuous reception (DRX) parameters based on data traffic, mobility, energy consumption, etc. to configure the discontinuous reception (DRX) parameter.

In the above embodiment, first, when the discontinuous reception (DRX) parameter is selected, since the base station needs to use the auxiliary information of the terminal, the terminal needs to report some auxiliary information in real time. For example, the terminal needs to report the discontinuous reception (DRX) parameter configuration information, traffic characteristic information and mobility information, etc. recommended by the terminal in real time. Since the transmission of the above auxiliary information requires periodic communication between the terminal and the base station, this will increase signaling overhead. Secondly, there is a delay in the communication between the terminal and the base station, which causes the base station to be unable to obtain real-time auxiliary information in time, and causes the base station to be unable to make decisions that conform to the timely scenario. Furthermore, the selection of discontinuous reception (DRX) parameters by the terminal and the communication with the base station all require power consumption, resulting in high power consumption. In addition, the terminal has limited computing capability, and cannot accurately calculate and recommend suitable discontinuous reception (DRX) parameter. In addition, the auxiliary information sent by the terminal to the base station may involve data privacy, which may bring security risks.

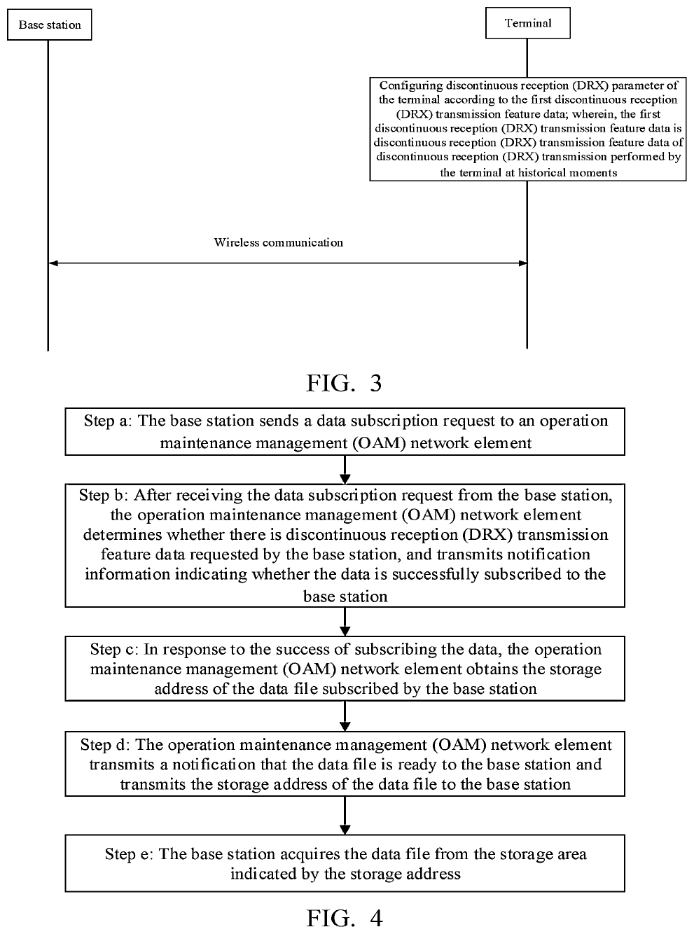

As shown in FIG. 3, this embodiment provides a method for configuring discontinuous reception (DRX) parameter, wherein, when applied to a base station, the method includes:

Step 31: configuring discontinuous reception (DRX) parameter of the terminal according to the first discontinuous reception (DRX) transmission feature data; wherein, the first discontinuous reception (DRX) transmission feature data is discontinuous reception (DRX) transmission feature data of discontinuous reception (DRX) transmission performed by the terminal at historical moments.

In one embodiment, the terminal may be, but is not limited to, a mobile phone, a wearable device, a vehicle-mounted terminal, a roadside unit (RSU), a smart home terminal, an industrial sensing device, and/or a medical device, and the like.

In one embodiment, the base station is an interface device for the terminal to access the network. The base station may be various types of base stations, for example, a base station of a third generation mobile communication (3G) network, a base station of a fourth generation mobile communication (4G) network, a base station of a fifth generation mobile communication (5G) network, or other evolved base station.

In one embodiment, discontinuous reception (DRX) transmission may be data transmission according to configured discontinuous reception (DRX) parameters. Here, the data transmission may be that the terminal receives or sends data.

In one embodiment, the discontinuous reception (DRX) parameters may include at least: a discontinuous reception (DRX) cycle.

In another embodiment, the discontinuous reception (DRX) parameter further includes: configuration parameter of the inactive timer and/or configuration parameter of the power saving signal, and the like.

In one embodiment, a discontinuous reception (DRX) cycle includes an active period and a sleep period.

In one embodiment, when in the active period of the discontinuous reception (DRX) cycle, the terminal can receive data and/or transmit data; when in the sleep period of the discontinuous reception (DRX) cycle, the terminal cannot receive data and/or transmit data. For example, during the active period, the antenna and/or the transceiver of the terminal are in an activated state, and can receive and/or transmit uplink and downlink data.

Here, the power consumption of the terminal operating in the active period of the discontinuous reception (DRX) cycle is greater than the power consumption of the terminal operating in the sleep period of the discontinuous reception (DRX) cycle. The data transmission based on the discontinuous reception (DRX) cycle can effectively reduce the power consumption of the terminal.

In one embodiment, the duration of the active period of the discontinuous reception (DRX) cycle may be determined according to the power consumption requirement of the terminal.

In one embodiment, when the required power consumption of the terminal is less than the power consumption threshold, the duration of the active period of the discontinuous reception (DRX) cycle may be less than the duration threshold. When the required power consumption of the terminal may be greater than the power consumption threshold, the duration of the activation period of the discontinuous reception (DRX) cycle may be greater than the duration threshold. In this way, the duration of the active period of the discontinuous reception (DRX) cycle can be adapted to the required power consumption of the terminal.

In one embodiment, a Wake Up Signal (WUS) is introduced in the radio resource control (RRC) connected state, and the wake up signal (WUS) can indicate whether the terminal needs to monitor the Physical Downlink Control Channel (PDCCH) before the arrival of each active period of the discontinuous reception (DRX).

In one embodiment, if no downlink data is sent, the terminal is instructed to perform sleep in the next discontinuous reception (DRX) cycle; otherwise, the physical downlink control channel (PDCCH) continues to be monitored in the next active period of discontinuous reception (DRX).

In one embodiment, the base station periodically acquires data transmitted by discontinuous reception (DRX).

In one embodiment, the data transmitted by the discontinuous reception (DRX) includes data of at least one of the following related to the discontinuous reception (DRX) transmission process of the terminal: historical data of service traffic, historical data of transmission conditions, historical data of user buffer capacity and historical data of discontinuous reception (DRX) parameter. In one embodiment, the historical data of service traffic includes: data such as traffic of data stream from the network side to the terminal received by the base station, time information, duration information occupied by one data stream transmission and transmitting rate.

In an embodiment, the historical data of the transmission conditions includes data such as the transmission rate, delay, and congestion of the downlink channel from the base station to the terminal.

In one embodiment, the historical data of discontinuous reception (DRX) parameters includes: discontinuous reception (DRX) cycle information, on-timer information of discontinuous reception (DRX), and inactive timer information of discontinuous reception (DRX).

In one embodiment, the historical data of the user buffer capacity is data of the remaining capacity of the buffer area of the terminal at the historical moment. In one embodiment, the discontinuous reception (DRX) transmission feature data may be feature data obtained after feature extraction is performed on the data transmitted by discontinuous reception (DRX) by using a feature extraction algorithm. For example, the discontinuous reception (DRX) transmission feature data may be feature data obtained by performing feature extraction on the data transmitted by discontinuous reception (DRX) by using a principal component analysis (PCA) algorithm.

In one embodiment, the base station may acquire discontinuous reception (DRX) transmission feature data from an Operation Administration and Maintenance (OAM) network element.

Please refer to FIG. 4, the steps for the base station to obtain discontinuous reception (DRX) transmission feature data from the operation maintenance management (OAM) network element, including:

Step a: The base station sends a data subscription request to an operation maintenance management (OAM) network element.

Here, the base station may encapsulate the discontinuous reception (DRX) transmission feature data information that needs to be acquired into a message, and send it to an operation maintenance management (OAM) network element through a data subscription request.

Step b: After receiving the data subscription request from the base station, the operation maintenance management (OAM) network element determines whether there is discontinuous reception (DRX) transmission feature data requested by the base station, and sends notification information indicating whether the data is successfully subscribed to the base station.

Step c: In response to the success of subscribing the data, the operation maintenance management (OAM) network element obtains the storage address of the data file subscribed by the base station. Here, the data file includes discontinuous reception (DRX) transmission feature data required by the base station.

Step d: The operation maintenance management (OAM) network element transmits a notification that the data file is ready to the base station and sends the storage address of the data file to the base station.

Step e: The base station acquires the data file from the storage area indicated by the storage address.

Here, the base station may acquire the data file from the storage area in a file transfer manner based on the file transfer protocol (FTP) or the secure file transfer protocol (SFTP).

In one embodiment, the first discontinuous reception (DRX) transmission feature data may be discontinuous reception (DRX) transmission feature data of the discontinuous reception (DRX) transmission performed by the terminal within a predetermined historical period.

In one embodiment, when subscribing to discontinuous reception (DRX) transmission feature data, the base station may carry the information of the predetermined historical period in the data subscription request. In this way, the operation maintenance management (OAM) network element may determine that the data requested by the base station to subscribe is the first discontinuous reception (DRX) transmission feature data of the discontinuous reception (DRX) transmission performed by the terminal within a predetermined historical period.

In one embodiment, the first discontinuous reception (DRX) transmission feature data of the discontinuous reception (DRX) transmission in the historical period may be used to predict the discontinuous reception (DRX) parameters to obtain the first discontinuous reception (DRX) parameter, and the first discontinuous reception (DRX) parameter is used to configure the discontinuous reception (DRX) parameter of the terminal.

In one embodiment, a neural network model may be used to predict discontinuous reception (DRX) parameter to obtain the first discontinuous reception (DRX) parameters. Here, the neural network model is a network model trained by using the first discontinuous reception (DRX) transmission feature data of the discontinuous reception (DRX) transmission in a historical period. The first discontinuous reception (DRX) parameter can be obtained after inputting the second discontinuous reception (DRX) transmission feature data of the discontinuous reception (DRX) transmission performed by the terminal at the current moment into the neural network model.

In this way, the terminal does not need to recommend the first discontinuous reception (DRX) parameter to the base station, but performs prediction based on the neural network model to obtain the first discontinuous reception (DRX) parameter. In this way, the time delay of data interaction between the base station and the terminal can be reduced, and the signaling overhead can also be reduced. Meanwhile, the delay caused by the terminal estimating a recommended discontinuous reception parameter and transmitting the recommended discontinuous reception parameter to the base station can be reduced.

In one embodiment, when the error of the first discontinuous reception (DRX) parameter is required to be less than an error threshold, the duration of the history period may be set to be greater than a set duration; when the error of the first discontinuous reception (DRX) parameter is required to be greater than the error threshold, the duration of the historical period may be set to be less than the set duration. In this way, the set duration of the historical period can be adaptively adjusted according to the error of the first discontinuous reception (DRX) parameter.

In one embodiment, when the terminal is not configured with discontinuous reception (DRX) parameters, the first discontinuous reception (DRX) parameters may be configured as discontinuous reception (DRX) parameters of the terminal.

In one embodiment, when the terminal is configured with discontinuous reception (DRX) parameters, the first discontinuous reception (DRX) parameters may be reconfigured as discontinuous reception (DRX) parameters of the terminal.

In one embodiment, configuring discontinuous reception (DRX) parameters for the terminal includes sending a first discontinuous reception (DRX) parameter to the terminal.

In an embodiment, the base station re-establishes a radio resource control (RRC) connection with the terminal. The base station sends the first discontinuous reception (DRX) parameter to the terminal through radio resource control (RRC) signaling. The terminal configures the first discontinuous reception (DRX) parameter carried in the radio resource control (RRC) signaling as the discontinuous reception (DRX) parameter of the terminal. After the terminal completes the configuration of discontinuous reception (DRX) parameters, the radio resource control (RRC) connection is released.

In this embodiment of the present disclosure, firstly, the terminal may configure discontinuous reception (DRX) parameters of the terminal according to the first discontinuous reception (DRX) transmission feature data. Since different first discontinuous reception (DRX) transmission feature data correspond to different discontinuous reception (DRX) transmission scenarios, the discontinuous reception (DRX) parameters of the terminal configured based on the first discontinuous reception (DRX) transmission feature data can be more suitable for the data transmission of the terminal in different discontinuous reception (DRX) transmission scenarios, thereby enabling the terminal to better meet the power consumption requirements in different discontinuous reception (DRX) transmission scenarios, extending the battery life of the terminal, and improving the user experience.

It should be noted that those skilled in the art can understand that the methods provided in the embodiments of the present disclosure may be performed alone, or may be performed together with some methods in the embodiments of the present disclosure or some methods in related technologies.

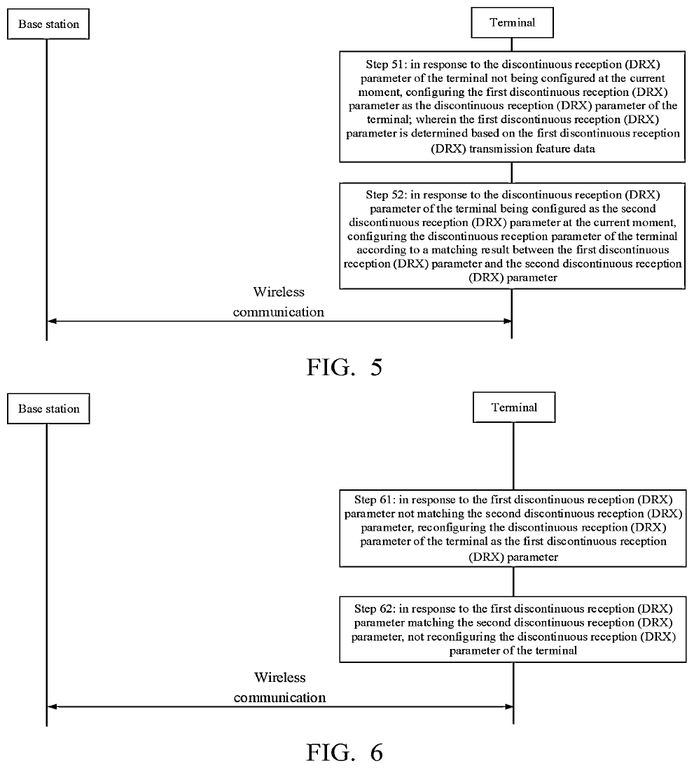

As shown in FIG. 5, according to this embodiment, a method for configuring discontinuous reception (DRX) parameters is provided, wherein the method includes:

Step 51: in response to the discontinuous reception (DRX) parameter of the terminal not being configured at the current moment, configuring the first discontinuous reception (DRX) parameter as the discontinuous reception (DRX) parameter of the terminal; wherein the first discontinuous reception (DRX) parameter is determined based on the first discontinuous reception (DRX) transmission feature data;

Step 52: in response to the discontinuous reception (DRX) parameter of the terminal being configured as the second discontinuous reception (DRX) parameter at the current moment, configuring the discontinuous reception parameter of the terminal according to a matching result between the first discontinuous reception (DRX) parameter and the second discontinuous reception (DRX) parameter.

In one embodiment, the first discontinuous reception (DRX) parameter for the discontinuous reception (DRX) parameter configuration of the terminal may be predicted by a neural network model trained based on the first discontinuous reception (DRX) transmission feature data of the discontinuous reception (DRX) transmission performed by the terminal at historical moments.

In one embodiment, the first discontinuous reception (DRX) parameter for the discontinuous reception (DRX) parameter configuration of the terminal may be acquired by inputting the second discontinuous reception (DRX) feature data of the currently undergoing discontinuous reception (DRX) transmission into a neural network model, wherein the neural network model is trained based on the first discontinuous reception (DRX) transmission feature data.

In one embodiment, when the discontinuous reception (DRX) parameter of the terminal is not configured at the current moment, the terminal does not perform discontinuous reception (DRX) transmission.

In one embodiment, in response to that the terminal needs to perform discontinuous reception (DRX) transmission, the terminal sends a request message for configuring discontinuous reception (DRX) parameters to the base station. In response to the base station receiving the request message of the discontinuous reception (DRX) parameter, the base station configures discontinuous reception (DRX) parameters of the terminal. Here, configuring the discontinuous reception (DRX) parameter of the terminal includes transmitting the first discontinuous reception (DRX) parameter to the terminal.

In an embodiment, the base station re-establishes a radio resource control (RRC) connection with the terminal. The base station sends the first discontinuous reception (DRX) parameter to the terminal through radio resource control (RRC) signaling. The terminal configures the first discontinuous reception (DRX) parameter carried in the radio resource control (RRC) signaling as the discontinuous reception (DRX) parameter of the terminal. After the terminal completes the configuration of discontinuous reception (DRX) parameters, the radio resource control (RRC) connection is released.

In one embodiment, the first discontinuous reception (DRX) parameter may be a set including a plurality of discontinuous reception (DRX) parameters. The second discontinuous reception (DRX) parameter may also be a set including a plurality of discontinuous reception (DRX) parameters. The types of discontinuous reception (DRX) parameters included in the first discontinuous reception (DRX) parameter and the second discontinuous reception (DRX) parameter are the same.

In one embodiment, when a discontinuous reception (DRX) parameter corresponding to any type of the first discontinuous reception (DRX) parameter is not equal to a discontinuous reception (DRX) parameter corresponding to any type of the second discontinuous reception (DRX) parameters, the first discontinuous reception (DRX) parameter does not match the second discontinuous reception (DRX) parameter.

In one embodiment, when discontinuous reception (DRX) parameters corresponding to all types of the first discontinuous reception (DRX) parameters are equal to the discontinuous reception (DRX) parameters corresponding to all types of the second discontinuous reception (DRX) parameters, the first discontinuous reception (DRX) parameters match the second discontinuous reception (DRX) parameters.

In one embodiment, when a difference between a discontinuous reception (DRX) parameter corresponding to any type of the first discontinuous reception (DRX) parameter and a discontinuous reception (DRX) parameter corresponding to any type of the second discontinuous reception (DRX) parameter is not within a threshold range, the first discontinuous reception (DRX) parameter does not match the second discontinuous reception (DRX) parameter.

In one embodiment, when differences between discontinuous reception (DRX) parameters corresponding to all types of the first discontinuous reception (DRX) parameters and discontinuous reception (DRX) parameters corresponding to all types of the second discontinuous reception (DRX) parameters are within a threshold range, the first discontinuous reception (DRX) parameters match the second discontinuous reception (DRX) parameters.

In one embodiment, the matching result between the first discontinuous reception (DRX) parameter and the second discontinuous reception (DRX) parameter may be that the first discontinuous reception (DRX) parameter is greater than, less than or equal to the second discontinuous reception (DRX) parameter. In one embodiment, in response to the first discontinuous reception (DRX) parameter not being equal to the second discontinuous reception (DRX) parameter, the first discontinuous reception (DRX) parameter does not match the second discontinuous reception (DRX) parameter.

In one embodiment, in response to the first discontinuous reception (DRX) parameter being equal to the second discontinuous reception (DRX) parameter, the first discontinuous reception (DRX) parameter matches the second discontinuous reception (DRX) parameter.

In one embodiment, the matching result between the first discontinuous reception (DRX) parameter and the second discontinuous reception (DRX) parameter may be the difference between the first discontinuous reception (DRX) parameter and the second discontinuous reception (DRX) is either within or beyond the threshold range.

In one embodiment, in response to the difference between the first discontinuous reception (DRX) parameter and the second discontinuous reception (DRX) parameter being within a threshold range, the first discontinuous reception (DRX) parameter and the second discontinuous reception (DRX) parameter match.

In one embodiment, in response to the difference between the first discontinuous reception (DRX) parameter and the second discontinuous reception (DRX) parameter being beyond a threshold range, the first discontinuous reception (DRX) parameter does not match the second discontinuous reception (DRX) parameter. It should be noted that those skilled in the art can understand that the methods provided in the embodiments of the present disclosure may be executed alone, or may be executed together with some methods in the embodiments of the present disclosure or some methods in related technologies.

As shown in FIG. 6, according to the embodiment, a method for configuring discontinuous reception (DRX) parameter is provided, wherein the method includes:

Step 61: in response to the first discontinuous reception (DRX) parameter not matching the second discontinuous reception (DRX) parameter, reconfiguring the discontinuous reception (DRX) parameter of the terminal as the first discontinuous reception (DRX) parameter;

Step 62: in response to the first discontinuous reception (DRX) parameter matching the second discontinuous reception (DRX) parameter, not reconfiguring the discontinuous reception (DRX) parameter of the terminal.

In one embodiment, in response to the difference between the first discontinuous reception (DRX) parameter and the second discontinuous reception (DRX) parameter being beyond a threshold range, the first discontinuous reception (DRX) parameter is reconfigured as DRX parameter of the terminal. In response to the difference between the first discontinuous reception (DRX) parameter and the second discontinuous reception (DRX) parameter being within the threshold range, the discontinuous reception (DRX) parameter of the terminal is not reconfigured.

In one embodiment, in response to the first discontinuous reception (DRX) parameter not being equal to the second discontinuous reception (DRX) parameter parameter, the first discontinuous reception (DRX) parameter is reconfigured as the discontinuous reception (DRX) of the terminal. In response to the first discontinuous reception (DRX) parameter being equal to the second discontinuous reception (DRX) parameter, the discontinuous reception (DRX) parameter of the terminal is not reconfigured.

In one embodiment, reconfiguring discontinuous reception (DRX) parameter of the terminal includes transmitting first discontinuous reception (DRX) parameters to the terminal.

In an embodiment, the base station re-establishes a radio resource control (RRC) connection with the terminal. The base station transmits the first discontinuous reception (DRX) parameter to the terminal through radio resource control (RRC) signaling. The terminal configures the first discontinuous reception (DRX) parameter carried in the radio resource control (RRC) signaling as the discontinuous reception (DRX) parameter of the terminal. After the terminal has received discontinuous reception (DRX) parameters, the radio resource control (RRC) connection is released.

It should be noted that those skilled in the art can understand that the methods provided in the embodiments of the present disclosure may be executed alone, or may be executed together with some methods in the embodiments of the present disclosure or some methods in related technologies.

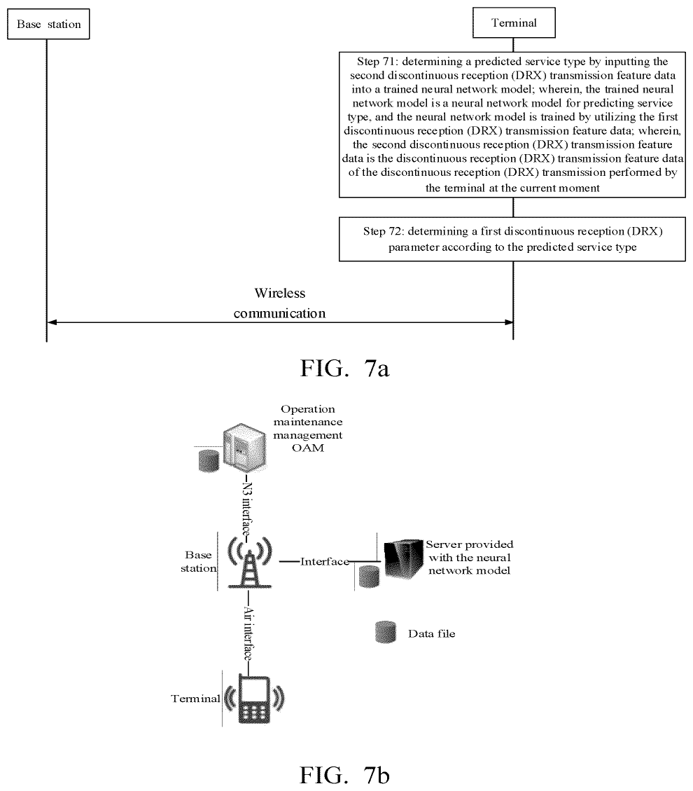

As shown in FIG. 7a, according to the embodiment, a method for configuring discontinuous reception (DRX) parameter is provided, wherein the method includes:

Step 71: determining a predicted service type by inputting the second discontinuous reception (DRX) transmission feature data into a trained neural network model; wherein, the trained neural network model is a neural network model for predicting service type, and the neural network model is trained by utilizing the first discontinuous reception (DRX) transmission feature data; wherein, the second discontinuous reception (DRX) transmission feature data is the discontinuous reception (DRX) transmission feature data of the discontinuous reception (DRX) transmission performed by the terminal at the current moment;

Step 72: determining a first discontinuous reception (DRX) parameter according to the predicted service type.

In one embodiment, the neural network model may be set in the base station, or may be set in other communication node outside the base station.

In one embodiment, the neural network model acquires first discontinuous reception (DRX) transmission feature data of the discontinuous reception (DRX) transmission performed by the terminal at historical moments.

In one embodiment, the first discontinuous reception (DRX) transmission feature data is obtained by the base station from an operation maintenance management (OAM) network element.

In one embodiment, if the neural network model is set in other communication node outside the base station, the communication node needs to acquire discontinuous reception (DRX) transmission feature data from the base station.

In one embodiment, referring to FIG. 7b, the neural network model is set in a server outside the base station, and the wireless communication system includes a terminal, a base station, an operation maintenance management (OAM) network element and a server provided with the neural network model.

In one embodiment, after acquiring the first discontinuous reception (DRX) transmission feature data, the neural network model classifies the discontinuous reception (DRX) transmission feature data.

In one embodiment, the method for classifying the first discontinuous reception (DRX) transmission feature data includes: after the neural network model receives the first discontinuous reception (DRX) transmission feature data, according to a random sampling method, randomly selecting A% of the first discontinuous reception (DRX) transmission feature data from the total data set as a training set, and selecting (100-a)% of the first discontinuous reception (DRX) transmission feature data as a test set. For example, a is 80, and the data is divided into training set and test set according to the ratio of 4:1, which are recorded as training set D^{train} and test set D^{test} respectively.

In one embodiment, the structure of the neural network model includes: an input layer, an output layer, a hidden layer, a connection mode between layers, and the like.

In one embodiment, the number of input layer nodes may be determined according to the number of types of first discontinuous reception (DRX) transmission feature data of the sample. For example, N input layer nodes may be set. Among them, N is a positive integer greater than or equal to 1.

In one embodiment, each input layer node corresponds to one type of first discontinuous reception (DRX) transmission feature data for neural network model training in the neural network model.

In one embodiment, the number of hidden layers can be set to L layers, and L can be determined according to the size of N, wherein the number of nodes of each hidden layer can be set to M, and the size of M is based on the generalization ability of the neural network model. L and M are positive integers greater than or equal to 1.

In one embodiment, the output layer is used for outputting results, and the number of nodes in the output layer can be set to S. Among them, S is a positive integer greater than or equal to 1. Here, the output result may be the probability that the predicted service is the service of target service type.

In one embodiment, there's full connection between the hidden layer and the input layer, and the hidden layer and there's also full connection between the hidden layers, and the activation function used is the relu function.

In one embodiment, there's full connection between the hidden layer and the output layer, and the activation function used is a softmax function.

In one embodiment, in the process of model training, the data value may be transferred in a forward transfer manner, and the gradient value may be transferred in a reverse transfer manner.

In one embodiment, for the hyperparameters of the neural network model, the number of learning times may be set to T times, and the setting of the number of learning times is determined according to the training speed of the neural network model and the training accuracy of the neural network model. T is a positive integer greater than 1.

In one embodiment, the learning rate can be set as α and β, and the selection of the learning rate is determined according to the generalization ability of the neural network model, where α and β are natural numbers.

In one embodiment, a cross-entropy function is selected as the loss function.

In one embodiment, random weight initialization is selected as the method of weight initialization.

In one embodiment, the batch size of the data is set to B, and the value of B is determined according to the size of the input data set. B is a positive integer greater than 1.

In one embodiment, the training set D^{train} and the test set D^{test} is used as samples in the neural network model, and the neural network model is trained according to the predetermined structure and hyperparameters of the neural network model.

In one embodiment, in each round of training, firstly the training set D^{train} is used to train the neural network model, and then the test set D^{test} is used to detect the results of the trained neural network model. If the error of the trained neural network model is less than the error threshold, the training is stopped, and the trained neural network model is obtained. If the error of the trained neural network is greater than the error threshold, continue the next round of training until all rounds of training are completed.

In one embodiment, the model training and calculation module first uses the training set D^{train}, adopts the gradient descent method, calculates the training loss and gradient of the parameter θ^{t}, and updates the parameter ϕ^{t}:

ϕ^{t}=θ^{t}−α∇_{θ}L(θ^{t}, D^{train})

Among them, θ represents the model parameter set to be updated, α and β represent the learning rate, L represents the loss function, t represents the iteration round, θ^{t} represents the model parameter set of the t-th iteration, D^{train} represents the training set, and D^{test} represents the test set.

According to the test loss and gradient of ϕ^{t} in the test set D^{test}, update the model parameter θ^{t+1}:

θ^{t+1}=θ^{t}−β∇_{θ}L(θ^{t}, D^{test})

It should be noted that those skilled in the art can understand that the methods provided in the embodiments of the present disclosure may be executed alone, or may be executed together with some methods in the embodiments of the present disclosure or some methods in related technologies.

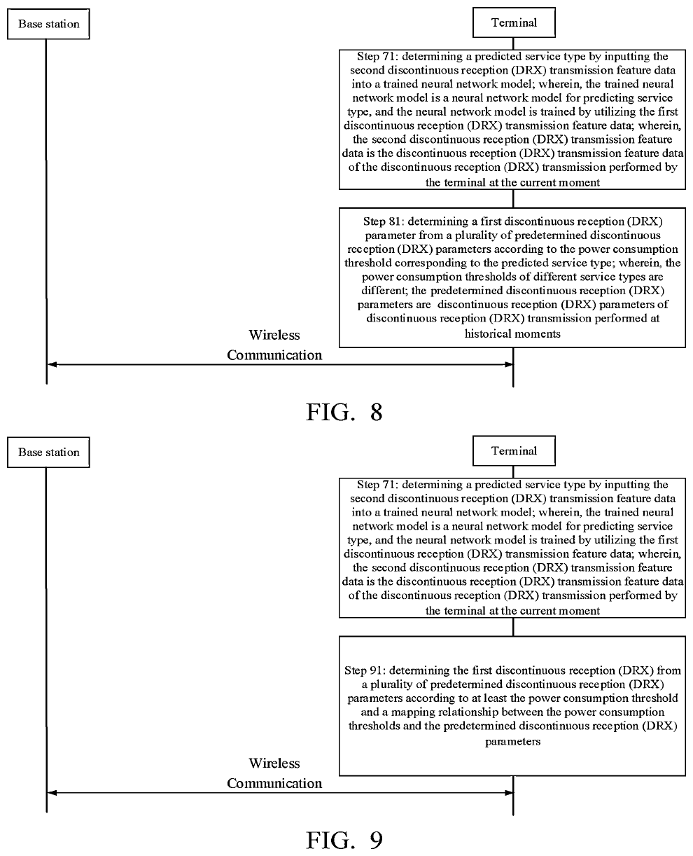

As shown in FIG. 8, according to the embodiment, a method for configuring discontinuous reception (DRX) parameter is provided, wherein the method includes:

Step 81: determining a first discontinuous reception (DRX) parameter from a plurality of predetermined discontinuous reception (DRX) parameters according to the power consumption threshold corresponding to the predicted service type; wherein, the power consumption thresholds of different service types are different; the predetermined discontinuous reception (DRX) parameters are discontinuous reception (DRX) parameters of discontinuous reception (DRX) transmissions performed at historical moments.

In one embodiment, the predetermined discontinuous reception (DRX) parameter is a discontinuous reception (DRX) parameter of discontinuous reception (DRX) transmission performed by the terminal within a historical period. In this way, the deviation between the first discontinuous reception (DRX) parameter and the discontinuous reception (DRX) parameter used by the terminal is small, and the terminal can better adapt to the first discontinuous reception (DRX) parameter.

In one embodiment, the predetermined discontinuous reception (DRX) parameter is a discontinuous reception (DRX) parameter of discontinuous reception (DRX) transmission performed within a historical period.

In one embodiment, the predetermined discontinuous reception (DRX) parameters may be obtained from an operation maintenance management (OAM) network element. When subscribing to the data of the predetermined discontinuous reception (DRX) parameter from the operation maintenance management (OAM) network element, the subscription request may carry the information of the implementation time period.

In one embodiment, the first discontinuous reception (DRX) with the power consumption threshold corresponding to the predicted service type may be determined according to the correspondence between a plurality of predetermined discontinuous reception (DRX) parameters and the corresponding power consumption.

It should be noted that those skilled in the art can understand that the methods provided in the embodiments of the present disclosure may be executed alone, or may be executed together with some methods in the embodiments of the present disclosure or some methods in related technologies.

As shown in FIG. 9, according to the embodiment, a method for configuring discontinuous reception (DRX) parameter is provided, wherein the method includes:

Step 91: determining the first discontinuous reception (DRX) from a plurality of predetermined discontinuous reception (DRX) parameters according to at least the power consumption threshold and the correspondence between the power consumption threshold and the predetermined discontinuous reception (DRX) parameter.

In one embodiment, each discontinuous reception (DRX) parameter corresponds to a power consumption threshold. The first discontinuous reception (DRX) parameter may be determined from the plurality of predetermined discontinuous reception (DRX) parameters according to the correspondence between the plurality of predetermined discontinuous reception (DRX) parameters and the corresponding power consumption thresholds. When the first discontinuous reception (DRX) parameter is used for data transmission, the power consumption generated by the data transmission is less than the power consumption threshold.

In one embodiment, the base station pre-stores a correspondence between the power consumption threshold and a predetermined discontinuous reception (DRX) parameter.

In one embodiment, discontinuous reception (DRX) transmission feature data includes: discontinuous reception (DRX) transmission feature data obtained from an operation maintenance management (OAM) network element.

In one embodiment, discontinuous reception (DRX) transmission feature data includes at least one of the following: data of traffic performance, data of channel transmission performance, and data of energy consumption.

It should be noted that those skilled in the art can understand that the methods provided in the embodiments of the present disclosure may be executed alone, or may be executed together with some methods in the embodiments of the present disclosure or some methods in related technologies.

In order to better understand any embodiment of the present disclosure, the solution of the present disclosure will be further described below through exemplary embodiments:

### EXAMPLE 1

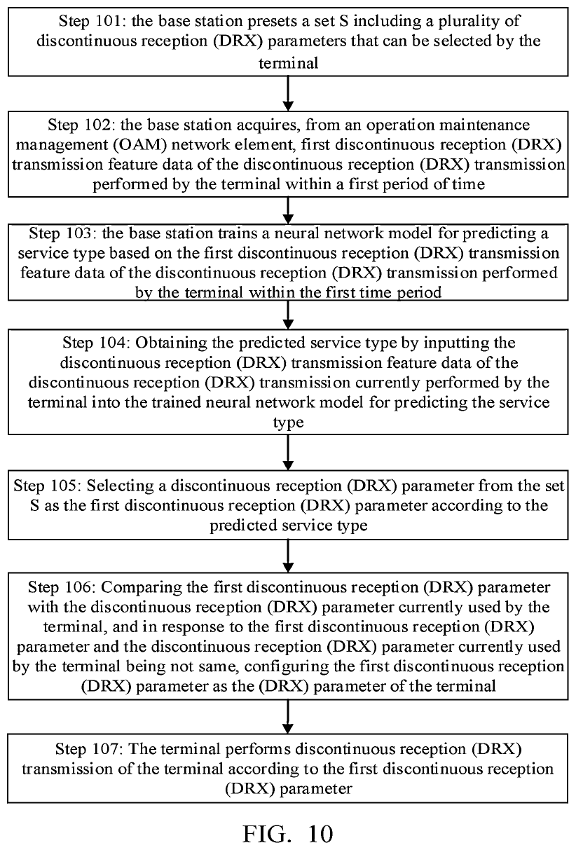

Referring to FIG. 10, according to the embodiment, a method for configuring discontinuous reception (DRX) parameter is provided, including:

Step 101: The base station presets a set S including a plurality of discontinuous reception (DRX) parameters that can be selected by the terminal.

Step 102: The base station acquires, from an operation maintenance management (OAM) network element, first discontinuous reception (DRX) transmission feature data of the discontinuous reception (DRX) transmission performed by the terminal within a first period of time.

Step 103: The base station trains a neural network model for predicting a service type based on the first discontinuous reception (DRX) transmission feature data of the discontinuous reception (DRX) transmission performed by the terminal within the first time period.

Step 104: Obtaining the predicted service type by inputting the discontinuous reception (DRX) transmission feature data of the discontinuous reception (DRX) transmission currently performed by the terminal into the trained neural network model for predicting the service type.

Step 105: Selecting a discontinuous reception (DRX) parameter from the set S as the first discontinuous reception (DRX) parameter according to the predicted service type.

Step 106: Comparing the first discontinuous reception (DRX) parameter with the discontinuous reception (DRX) parameter currently used by the terminal, and in response to the first discontinuous reception (DRX) parameter and the discontinuous reception (DRX) parameter currently used by the terminal being not same, configuring the first discontinuous reception (DRX) parameter as the (DRX) parameter of the terminal.

Step 107: The terminal performs discontinuous reception (DRX) transmission of the terminal according to the first discontinuous reception (DRX) parameter.

It should be noted that those skilled in the art can understand that the methods provided in the embodiments of the present disclosure may be executed alone, or may be executed together with some methods in the embodiments of the present disclosure or some methods in related technologies.

### EXAMPLE 2

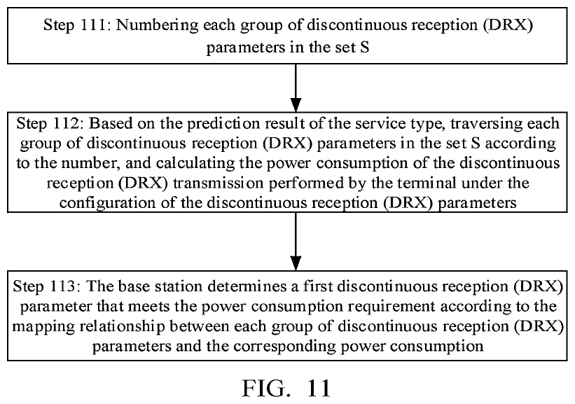

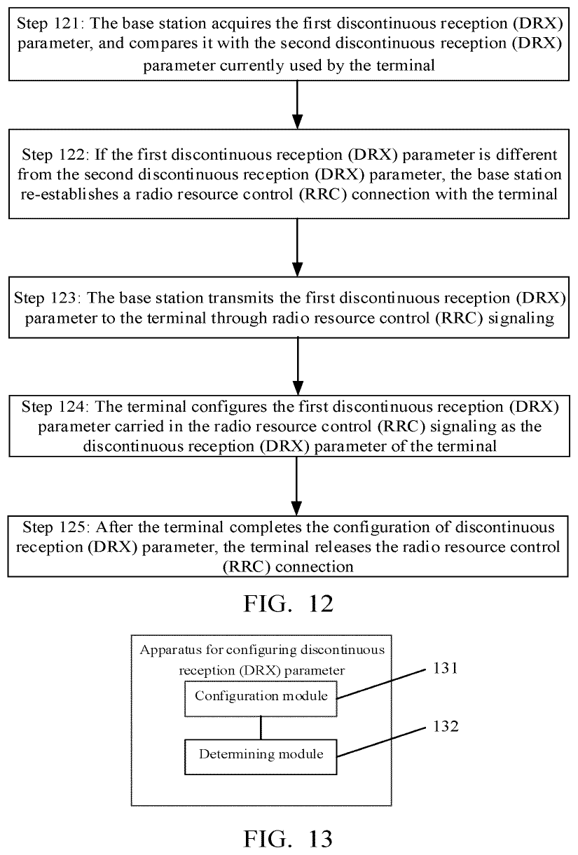

Referring to FIG. 11, according to the embodiment, a method for configuring discontinuous reception (DRX) parameters is provided, including:

Step 111: Numbering each group of discontinuous reception (DRX) parameters in the set S.

Step 112: Based on the prediction result of the service type, traversing each group of discontinuous reception (DRX) parameters in the set S according to the number, and calculating the power consumption of the discontinuous reception (DRX) transmission performed by the terminal under the configuration of the discontinuous reception (DRX) parameters.

Step 113: The base station determines a first discontinuous reception (DRX) parameter that meets the power consumption requirement according to the correspondence between each group of discontinuous reception (DRX) parameters and the corresponding power consumption. Here, meeting the power consumption requirement may be that the corresponding power consumption is less than the power consumption threshold.

It should be noted that those skilled in the art can understand that the methods provided in the embodiments of the present disclosure may be executed alone, or may be executed together with some methods in the embodiments of the present disclosure or some methods in related technologies.

### EXAMPLE 3

Referring to FIG. 12, according to the embodiment, a method for configuring discontinuous reception (DRX) parameter is provided, including:

Step 121: The base station acquires the first discontinuous reception (DRX) parameter, and compares it with the second discontinuous reception (DRX) parameter currently used by the terminal.

Step 122: If the first discontinuous reception (DRX) parameter is different from the second discontinuous reception (DRX) parameter, the base station re-establishes a radio resource control (RRC) connection with the terminal.

Step 123: The base station transmits the first discontinuous reception (DRX) parameter to the terminal through radio resource control (RRC) signaling.

Step 124: The terminal configures the first discontinuous reception (DRX) parameter carried in the radio resource control (RRC) signaling as the discontinuous reception (DRX) parameter of the terminal.

Step 125: After the terminal completes the configuration of discontinuous reception (DRX) parameter, the terminal releases the radio resource control (RRC) connection.

It should be noted that those skilled in the art can understand that the methods provided in the embodiments of the present disclosure may be executed alone, or may be executed together with some methods in the embodiments of the present disclosure or some methods in related technologies.

As shown in FIG. 13, according to an embodiment of the present disclosure, an apparatus for configuring discontinuous reception (DRX) parameter is provided, wherein, when applied to a base station, the apparatus includes a configuration module 131, wherein,

The configuration module 131 is configured to: perform discontinuous reception (DRX) parameter configuration of the terminal according to the first discontinuous reception (DRX) transmission feature data; wherein, the first discontinuous reception (DRX) transmission feature data is the discontinuous reception (DRX) transmission feature data of the discontinuous reception (DRX) transmission performed by the terminal at historical time.

In one embodiment, the configuration module 131 is also configured to:

in response to the discontinuous reception (DRX) parameter of the terminal not being configured at the current moment, configure the first discontinuous reception (DRX) parameter as the discontinuous reception (DRX) parameter of the terminal; wherein the first discontinuous reception (DRX) parameter is determined based on the first discontinuous reception (DRX) transmission feature data;

or,

in response to the discontinuous reception (DRX) parameter of the terminal being configured as the second discontinuous reception (DRX) parameter at the current moment, configure discontinuous reception (DRX) parameters of the terminal according to the matching result between the first discontinuous reception (DRX) parameter and the second discontinuous reception (DRX) parameter.

In one embodiment, the configuration module 131 is further configured to:

in response to a mismatch between the first discontinuous reception (DRX) parameter and the second discontinuous reception (DRX) parameter, reconfigure the first discontinuous reception (DRX) parameter as a discontinuous reception (DRX) parameter of the terminal;

or,

in response to the first discontinuous reception (DRX) parameter matching the second discontinuous reception (DRX) parameter, not reconfigure the discontinuous reception (DRX) parameter.

In one embodiment, the apparatus further includes a determining module 132, wherein the determining module 132 is configured to:

determine the prediction service type by inputting the second discontinuous reception (DRX) transmission feature data into the trained neural network model; wherein, the trained neural network model is a neural network model for predicting the service type and the neural network model is trained by using the first discontinuous reception (DRX) transmission feature data; wherein, the second discontinuous reception (DRX) transmission feature data is the discontinuous reception (DRX) transmission feature data of the discontinuous reception (DRX) transmission performed by the terminal at the current moment;

determine the first discontinuous reception (DRX) parameter according to the predicted service type.

In one embodiment, the determining module 132 is further configured to:

determine the first discontinuous reception (DRX) parameter from a plurality of predetermined discontinuous reception (DRX) parameters according to the power consumption threshold corresponding to the predicted service type; wherein, the power consumption thresholds of different service types are different; the predetermined discontinuous reception (DRX) parameter is a discontinuous reception (DRX) parameter of the discontinuous reception (DRX) transmission performed at a historical time.

In one embodiment, the determining module 132 is further configured to:

determine a first discontinuous reception (DRX) parameter from a plurality of predetermined discontinuous reception (DRX) parameters according to at least the power consumption threshold and the correspondence between the power consumption thresholds and the predetermined discontinuous reception (DRX) parameters.

In one embodiment, the discontinuous reception (DRX) transmission feature data includes: discontinuous reception (DRX) transmission feature data obtained from an operation maintenance management (OAM) network element.

In one embodiment, the discontinuous reception (DRX) transmission feature data includes at least one of the following: data of traffic performance, data of channel transmission performance, and data of energy consumption.

Regarding the apparatus in the above-mentioned embodiment, the specific manner in which each module performs operations has been described in detail in the embodiment of the method, and will not be described in detail here.

According to embodiments of the present disclosure, a communication device is provided, the communication device includes a processor and a memory for storing processor-executable instructions. The processor is configured to: when executing the executable instructions, implement the method applied to any embodiment of the present disclosure.

The processor may include various types of storage media, which are non-transitory computer storage media that can continue to memorize and store information on the communication device after the power is turned off

The processor can be connected to the memory through a bus or the like, and is used to read the executable program stored on the memory.

According to an embodiment of the present disclosure, a computer storage medium is further provided, wherein the computer storage medium stores a computer-executable program, and when the executable program is executed by a processor, the method of any embodiment of the present disclosure is implemented.

Regarding the apparatus in the above-mentioned embodiment, the specific manner in which each module performs operations has been described in detail in the embodiment of the method, and will not be described in detail here.

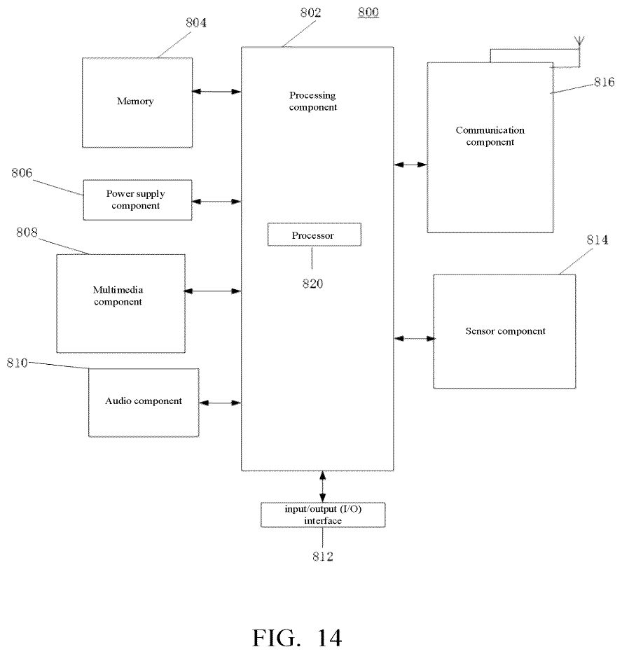

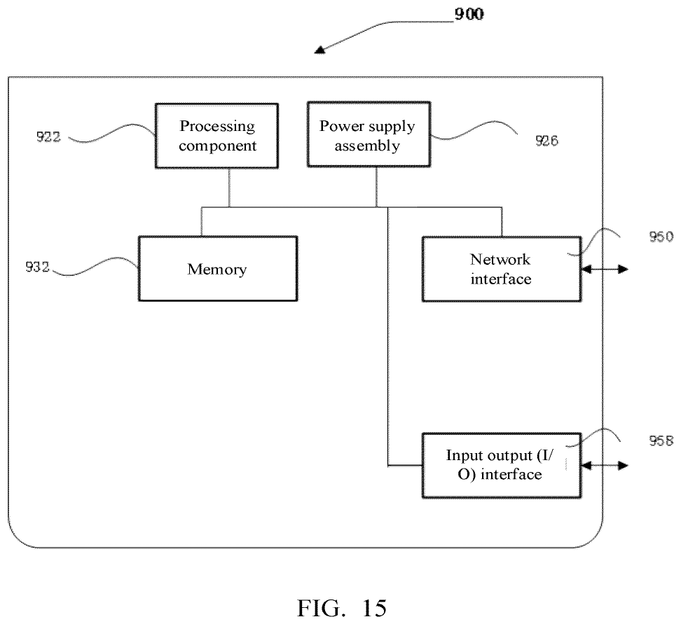

As shown in FIG. 14, according to an embodiment of the present disclosure, a structure of a terminal is provided.

Referring to the terminal 800 shown in FIG. 14, according to the embodiment, a terminal 800 is provided, which may be a mobile phone, a computer, a digital broadcasting terminal, a messaging device, a game console, a tablet device, a medical device, a fitness device, a personal digital assistant, etc.

Referring to FIG. 14, the terminal 800 may include one or more of the following components: a processing component 802, a memory 804, a power supply component 806, a multimedia component 808, an audio component 810, an input/output (I/O) interface 812, a sensor component 814, and communication component 816.

The processing component 802 generally controls the overall operations of the terminal 800, such as operations associated with display, phone calls, data communications, camera operations, and recording operations. The processing component 802 can include one or more processors 820 to execute instructions to perform all or some of the steps of the methods described above. Additionally, processing component 802 may include one or more modules that facilitate interaction between processing component 802 and other components. For example, processing component 802 may include a multimedia module to facilitate interaction between multimedia component 808 and processing component 802.

Memory 804 is configured to store various types of data to support operation at device 800. Examples of such data include instructions for any application or method operating on the terminal 800, contact data, phonebook data, messages, pictures, videos, and the like. Memory 804 may be implemented by any type of volatile or nonvolatile storage device or combination thereof, such as static random access memory (SRAM), electrically erasable programmable read only memory (EEPROM), erasable Programmable Read Only Memory (EPROM), Programmable Read Only Memory (PROM), Read Only Memory (ROM), Magnetic Memory, Flash Memory, Magnetic or Optical Disk.

Power supply component 806 provides power to various components of terminal 800. Power supply components 806 may include a power management system, one or more power supplies, and other components associated with generating, managing, and distributing power to terminal 800 .

Multimedia component 808 includes screens that provide an output interface between terminal 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touch, swipe, and gestures on the touch panel. A touch sensor can sense not only the boundaries of a touch or swipe action, but also the duration and pressure associated with the touch or swipe action. In some embodiments, the multimedia component 808 includes a front-facing camera and/or a rear-facing camera. When the device 800 is in an operation mode, such as a shooting mode or a video mode, the front camera and/or the rear camera may receive external multimedia data. Each of the front and rear cameras can be a fixed optical lens system or have focal length and optical zoom capability.

Audio component 810 is configured to output and/or input audio signals. For example, the audio component 810 includes a microphone (MIC) that is configured to receive external audio signals when the terminal 800 is in an operating mode, such as a calling mode, a recording mode, and a voice recognition mode. The received audio signal may be further stored in memory 804 or transmitted via communication component 816. In some embodiments, audio component 810 also includes a speaker for outputting audio signals.

The I/O interface 812 provides an interface between the processing component 802 and a peripheral interface module, which may be a keyboard, a click wheel, a button, or the like. These buttons may include, but are not limited to: home button, volume buttons, start button, and lock button.

Sensor assembly 814 includes one or more sensors for providing various aspects of the status assessment of terminal 800. For example, the sensor component 814 can detect the open/closed state of the device 800, the relative positioning of components, such as the display and keypad of the terminal 800, the sensor component 814 can also detect the position change of the terminal 800 or a component of the terminal 800, the presence or absence of contact between the user and the terminal 800, the orientation or acceleration/deceleration of the terminal 800 and the temperature change of the terminal 800. Sensor assembly 814 may include a proximity sensor configured to detect the presence of nearby objects in the absence of any physical contact. Sensor assembly 814 may also include a light sensor, such as a CMOS or CCD image sensor, for use in imaging applications. In some embodiments, the sensor assembly 814 may also include an acceleration sensor, a gyroscope sensor, a magnetic sensor, a pressure sensor, or a temperature sensor.

Communication component 816 is configured to facilitate wired or wireless communication between terminal 800 and other devices. The terminal 800 can access a wireless network based on a communication standard, such as Wi-Fi, 2G or 3G, or a combination thereof. In one exemplary embodiment, the communication component 816 receives broadcast signals or broadcast related information from an external broadcast management system via a broadcast channel. In one exemplary embodiment, the communication component 816 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology and other technologies.

In an exemplary embodiment, terminal 800 may be implemented by one or more application specific integrated circuits (ASICs), digital signal processors (DSPs), digital signal processing devices (DSPDs), programmable logic devices (PLDs), field programmable gate array (FPGA), controller, microcontroller, microprocessor or other electronic component, to perform the above method.

In an exemplary embodiment, there is also provided a non-transitory computer-readable storage medium including instructions, such as a memory 804 including instructions, which are executable by the processor 820 of the terminal 800 to perform the above method. For example, the non-transitory computer-readable storage medium may be ROM, random access memory (RAM), CD-ROM, magnetic tape, floppy disk, optical data storage device, and the like.

As shown in FIG. 15, according to an embodiment of the present disclosure, it shows a structure of a base station. For example, the base station 900 may be provided as a network-side device. Referring to FIG. 15, base station 900 includes processing component 922, which further includes one or more processors, and a memory resource represented by memory 932 for storing instructions executable by processing component 922, such as application programs. An application program stored in memory 932 may include one or more modules, each corresponding to a set of instructions. Additionally, the processing component 922 is configured to execute instructions to perform any of the aforementioned methods applied to the base station.

The base station 900 may also include: a power supply assembly 926, configured to perform power management of the base station 900; a wired or wireless network interface 950, configured to connect the base station 900 to a network; and an input output (I/O) interface 958. Base station 900 may operate based on an operating system stored in memory 932, such as Windows Server™, Mac OS X™, Unix™, Linux™, FreeBSD™ or the like.

In the embodiment of the present disclosure, the discontinuous reception (DRX) parameter configuration of the terminal is performed according to the first discontinuous reception (DRX) transmission feature data; wherein, the first discontinuous reception (DRX) transmission feature data is discontinuous reception (DRX) transmission feature data of discontinuous reception (DRX) transmission performed by the terminal at a historical moment. Here, the terminal may configure discontinuous reception (DRX) parameter of the terminal according to the first discontinuous reception (DRX) transmission feature data. Since the first discontinuous reception (DRX) transmission feature data corresponding to different discontinuous reception (DRX) transmission scenarios is different, in this way, the discontinuous reception (DRX) parameters of the terminal configured based on the first discontinuous reception (DRX) transmission feature data can be more suitable for the data transmissions of the terminal in different discontinuous reception (DRX) transmission scenarios, so that the terminal can better meet the power consumption requirements in different discontinuous reception (DRX) transmission scenarios, thereby prolonging the battery life of the terminal, and improving user experience.

Other embodiments of the invention will readily occur to those skilled in the art upon consideration of the specification and practice of the invention disclosed herein. This disclosure is intended to cover any modifications, uses, or adaptations of the invention that follow the general principles of the invention and include common general knowledge or techniques in the art not disclosed in this disclosure. The specification and examples are to be regarded as exemplary only, with the true scope and spirit of the invention being indicated by the following claims.

It should be understood that the present invention is not limited to the precise structures described above and illustrated in the accompanying drawings, and that various modifications and changes may be made without departing from its scope. The scope of the present invention is limited only by the appended claims.

1. A method for configuring discontinuous reception DRX parameter, performed by a base station, comprising:
configuring a DRX parameter of a terminal according to first DRX transmission feature data; wherein, the first DRX transmission feature data is DRX transmission feature data of DRX transmission performed by the terminal at a historical moment.

2. The method according to claim 1, wherein said configuring the DRX parameter of the terminal comprises:
configuring the DRX parameter of the terminal as a first DRX parameter when the DRX parameter of the terminal is not configured at a current moment; wherein, the first DRX parameter is determined based on the first DRX transmission feature data;
or,
configuring the DRX parameter of the terminal according to a matching result between the first DRX parameter and a second DRX parameter when the DRX parameter of the terminal is configured as the second DRX parameter at the current moment.

3. The method according to claim 2, wherein said configuring the DRX parameter of the terminal according to the matching result between the first DRX parameter and the second DRX parameter comprises:
reconfiguring the DRX parameter of the terminal as the first DRX parameter when the first DRX parameter does not match the second DRX parameter;
or,
not reconfiguring the DRX parameter of the terminal when the first DRX parameter matches the second DRX parameter.

4. The method according to claim 2, wherein the method comprises:
determining a predicted service type by inputting second DRX transmission feature data into a trained neural network model; wherein, the trained neural network model is a neural network model for predicting service type and the neural network model is trained by using the first DRX transmission feature data; wherein, the second DRX transmission feature data is DRX transmission feature data of DRX transmission performed by the terminal at the current moment;
determining the first DRX parameter according to the predicted service type.

5. The method according to claim 4, wherein said determining the first DRX parameter according to the predicted service type comprises:
determining the first DRX parameter from a plurality of predetermined DRX parameters according to a power consumption threshold corresponding to the predicted service type; wherein power consumption thresholds of different service types are different; the predetermined DRX parameters are DRX parameters of DRX transmissions performed at historical moments.

6. The method according to claim 5, wherein said determining the first DRX parameter from the plurality of predetermined DRX parameters according to the power consumption threshold corresponding to the predicted service type comprises:
determining the first DRX parameter from the plurality of predetermined DRX parameters according to the power consumption threshold and a correspondence between power consumption thresholds and the predetermined DRX parameters.

7. The method according to claim 1, wherein the DRX transmission feature data comprises: DRX transmission feature data obtained from an operation maintenance management OAM network element.

8. The method according to claim 1, wherein the DRX transmission feature data comprises at least one of the following: data of traffic performance, data of channel transmission performance, and data of energy consumption.

9-16. (canceled)

17. A communication device, comprising:
an antenna;
a memory;
a processor, respectively connected to the antenna and the memory, configured to control transmission and reception of the antenna, and implement the following steps by executing computer-executable instructions stored in the memory:
configuring DRX parameter of a terminal according to a first DRX transmission feature data; wherein, the first DRX transmission feature data is DRX transmission feature data of DRX transmission performed by the terminal at a historical moment.

18. A non-transitory computer storage medium storing computer-executable instructions, which can implement the following steps after the computer-executable instructions are executed by a processor:
configuring DRX parameter of a terminal according to a first DRX transmission feature data; wherein, the first DRX transmission feature data is DRX transmission feature data of DRX transmission performed by the terminal at a historical moment.

19. The communication device according to claim 17, wherein said configuring the DRX parameter of the terminal comprises:
configuring the DRX parameter of the terminal as a first DRX parameter when the DRX parameter of the terminal is not configured at a current moment; wherein, the first DRX parameter is determined based on the first DRX transmission feature data;
or,
configuring the DRX parameter of the terminal according to a matching result between the first DRX parameter and a second DRX parameter when the DRX parameter of the terminal is configured as the second DRX parameter at the current moment.

20. The communication device according to claim 19, wherein said configuring the DRX parameter of the terminal according to the matching result between the first DRX parameter and the second DRX parameter comprises:
reconfiguring the DRX parameter of the terminal as the first DRX parameter when the first DRX parameter does not match the second DRX parameter;
or,
not reconfiguring the DRX parameter of the terminal when the first DRX parameter matches the second DRX parameter.

21. The communication device according to claim 19, wherein following steps are further implemented by executing computer-executable instructions stored in the memory:
determining a predicted service type by inputting second DRX transmission feature data into a trained neural network model; wherein, the trained neural network model is a neural network model for predicting service type and the neural network model is trained by using the first DRX transmission feature data; wherein, the second DRX transmission feature data is DRX transmission feature data of DRX transmission performed by the terminal at the current moment;
determining the first DRX parameter according to the predicted service type.

22. The communication device according to claim 21, wherein said determining the first DRX parameter according to the predicted service type comprises:
determining the first DRX parameter from a plurality of predetermined DRX parameters according to a power consumption threshold corresponding to the predicted service type; wherein power consumption thresholds of different service types are different; the predetermined DRX parameters are DRX parameters of DRX transmissions performed at historical moments.

23. The communication device according to claim 22, wherein said determining the first DRX parameter from the plurality of predetermined DRX parameters according to the power consumption threshold corresponding to the predicted service type comprises:
determining the first DRX parameter from the plurality of predetermined DRX parameters according to at least the power consumption threshold and a correspondence between power consumption thresholds and the predetermined DRX parameters.

24. The communication device according to claim 17, wherein the DRX transmission feature data comprises: DRX transmission feature data obtained from an operation maintenance management OAM network element.

25. The communication device according to claim 17, wherein the DRX transmission feature data comprises at least one of the following: data of traffic performance, data of channel transmission performance, and data of energy consumption.

26. The non-transitory computer storage medium according to claim 18, wherein said configuring the DRX parameter of the terminal comprises:
configuring the DRX parameter of the terminal as a first DRX parameter when the DRX parameter of the terminal is not configured at a current moment; wherein, the first DRX parameter is determined based on the first DRX transmission feature data;
or,
configuring the DRX parameter of the terminal according to a matching result between the first DRX parameter and a second DRX parameter when the DRX parameter of the terminal is configured as the second DRX parameter at the current moment.

27. The non-transitory computer storage medium according to claim 26, wherein said configuring the DRX parameter of the terminal according to the matching result between the first DRX parameter and the second DRX parameter comprises:
reconfiguring the DRX parameter of the terminal as the first DRX parameter when the first DRX parameter does not match the second DRX parameter;
or,
not reconfiguring the DRX parameter of the terminal when the first DRX parameter matches the second DRX parameter.

28. The non-transitory computer storage medium according to claim 26, wherein following steps are further implemented by executing computer-executable instructions stored in the memory:
determining a predicted service type by inputting second DRX transmission feature data into a trained neural network model; wherein, the trained neural network model is a neural network model for predicting service type and the neural network model is trained by using the first DRX transmission feature data; wherein, the second DRX transmission feature data is DRX transmission feature data of DRX transmission performed by the terminal at the current moment;
determining the first DRX parameter according to the predicted service type.
